(19) United States
(12) Patent Application Publication
(10) Pub. No.: US 2008/0212324 A1
(43) Pub. Date: Sep. 4, 2008

(54) LED TABLE LAMP

(75) Inventor: Chia-Te Lin, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AMA PRECISION INC., Taipei (TW)

(21) Appl. No.: 11/935,413

(22) Filed: Nov. 6, 2007

(30) Foreign Application Priority Data
Mar. 1, 2007 (TW) 96106947

(51) Int. Cl. F21V 21/26; F21V 29/00

(52) U.S. Cl. 362/287

(57) ABSTRACT

A light emitting diode (LED) table lamp including a base, a support arm, a pivot, and a light emitting device is provided. One end of the support arm is connected to the base, and the pivot is provided at the other end of the support arm. The light emitting device includes a lampshade, a LED light assembly provided at the lampshade, and at least a heat pipe. The lampshade is pivotally connected to the support arm by the pivot, and the heat pipe is provided at the LED light assembly. In addition, an end of the heat pipe is tightly fitted with the pivot.

### CROSS-REFERENCE TO RELATED APPLICATION

This application claims the priority benefit of Taiwan application serial no. 96106947, filed on Mar. 1, 2007. All disclosure of the Taiwan application is incorporated herein by reference.

### BACKGROUND OF THE INVENTION

1. Field of the Invention

The present invention relates to a table lamp and, more particularly, to a light emitting diode (LED) table lamp provided with a heat pipe.

2. Description of the Related Art

In the daily life, people usually use a table lamp to get more brighter indoor area where the environment is dim. Therefore, a lamp can make an dark area such as a desk become a bright working environment, and users can read or do other things at the desk without worrying about the eyesight being affected by the insufficient light in the working environment.

Generally speaking, since the light emitting diode (LED) light source has a small dimension and a long lifespan, the LED table lamp has been more and more popular. FIG. 1 is a schematic diagram showing a conventional LED table lamp. Please refer to FIG. 1. A conventional LED table lamp 100 includes a base 110, a support arm 120 extending from the base 110 and a light emitting device 130. The light emitting device 130 has a lampshade 132, a LED light assembly 134 and a heat dissipation fins assembly 136. In the conventional technology, the lampshade 132 is pivotally connected to the support arm 120, the LED light assembly 134 is provided in the lampshade 132, and the heat dissipation fins assembly 136 is provided on the LED light assembly 134 to dissipate the heat for the LED light assembly 134.

According to the description above, a conventional LED table lamp 100 has heat dissipation fins assembly 136 provided on the light emitting device 130 for the heat convection with the surroundings to enhance the heat dissipation efficiency of the heat dissipation fins assembly 136, the lampshade 132 of the conventional LED table lamp 100 has a plurality of holes 132a, so that the heat conducted to the heat dissipation fins assembly 136 from the LED light assembly 134 can be dissipated to the surroundings via the holes 132a.

Although the design of forming a plurality of holes 132a on the lampshade 132 can enhance the heat dissipation efficiency of the heat dissipation fins assembly 136, it makes the overall appearance of the LED table lamp 100 unpreferred. In addition, if the wattage of the LED used is increased, the heat produced by the LED will exceed the expectation, and the size of the heat dissipation fins assembly 136 on the lampshade must be increased.

In addition, the conventional light emitting device 130 provided with the heat dissipation fins assembly 136 is big since the heat dissipation fins assembly 136 is oversized. Moreover, the oversized light emitting device 130 will also make the overall appearance unpreferred. Further, the heat generated from the conventional LED light assembly 134 is dissipated by the heavy and oversized heat dissipation fins assembly 136, therefore, a steady structure should be used to support the light emitting device 130, which increases the production cost.

### BRIEF SUMMARY OF THE INVENTION

One preferred embodiment of the present invention provides a light emitting diode (LED) table lamp having a preferred overall appearance. The light emitting device and the heat dissipation device of the LED table lamp not only are light and slim, but also have a lower production cost.

The LED table lamp of one preferred embodiment of the present invention includes a base, a support arm, a pivot and a light emitting device, wherein one end of the support arm is connected to the base, and the pivot is provided at the other end of the support arm. The light emitting device includes a lampshade, a LED light assembly provided at the lampshade and at least a heat pipe. The lampshade is pivotally connected to the support arm by the pivot. The heat pipe is provided at the LED light assembly, and one end of the heat pipe is tightly fitted with the pivot.

In one embodiment of the present invention, the LED light assembly further includes a circuit board, so that the LED light assembly is provided at one surface of the circuit board, and the heat pipe is provided at the other surface of the circuit board.

In one embodiment of the present invention, there is no limitation on the material of the pivot and the support arm, but to obtain a preferred heat dissipation effect, the material of the pivot and the support arm is preferred to be metal.

In one embodiment of the present invention, there is no limitation on the material of the base, but to obtain a preferred heat dissipation effect, the material of the base is preferred to be metal.

In one embodiment of the present invention, the LED table lamp further includes a lens provided at the lampshade to make the light emitted from the LED light assembly uniform.

In the LED table lamp of the present invention, at least a heat pipe is used to dissipate the heat produced by the LED light assembly to the support arm or the base. Since the support arm and the base have large area for heat convection with the surroundings, the heat produced by the LED light assembly can be effectively dissipated by the metal support arm or the metal base. In this way, the LED light assembly can be in a normal working temperature, and the LED table lamp has a longer working lifespan.

Compared with the conventional bigger and heavier heat dissipation fins assembly to dissipate heat from the LED light assembly, in this invention, the heat pipe is used to conduct the heat produced by the LED light assembly to the metal support arm or the metal base for heat convection with the surroundings by the support arm or the base. Therefore, the light emitting device of the present invention is light and slim, and the LED table lamp of the present invention has a preferred product appearance. Further, since the heat produced by the LED light assembly is dissipated by the metal support arm or the metal base via the heat pipe of the present invention, the holes on the lampshade for dissipating the heat for the LED light assembly of the conventional lamp are not needed. In other words, the LED table lamp of the present invention has a preferred product appearance.

In addition, since the light emitting device is light and slim, the LED table lamp of the present invention does not need heavy base to support the light emitting device. That is, the LED table lamp of the present invention has a lower product cost.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a conventional light emitting diode (LED) table lamp.

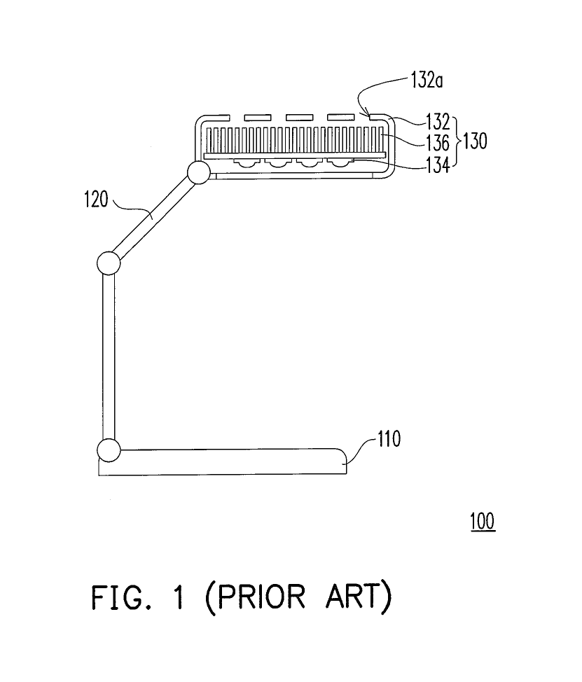

FIG. 2 is a schematic diagram showing a LED table lamp of one preferred embodiment of the present invention.

### DETAILED DESCRIPTION OF THE EMBODIMENTS

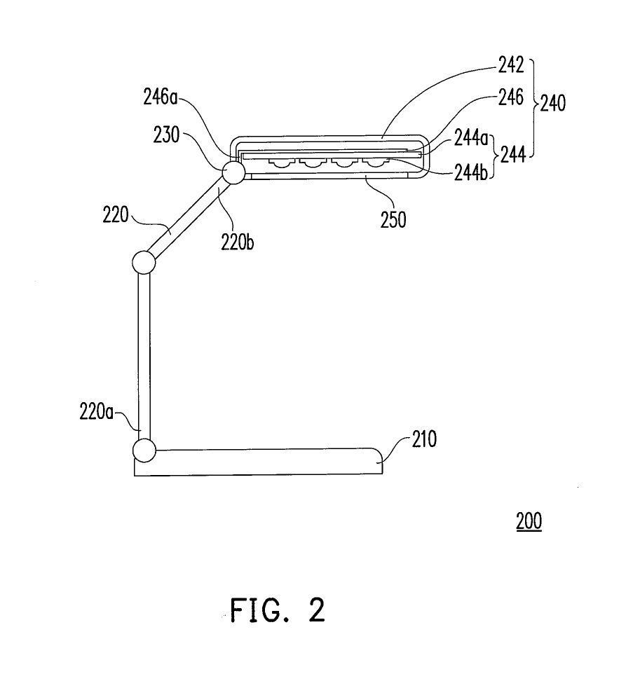

FIG. 2 is a schematic diagram showing a light emitting diode (LED) table lamp of one preferred embodiment of the present invention. Please refer to FIG. 2. A LED table lamp 200 of the embodiment includes a base 210, a support arm 220, a pivot 230 and a light emitting device 240. The material of the pivot 230, the support arm 220 and the base 210 is, for example, a metal which has a preferred heat conduction efficiency. In the embodiment, one end 220a of the support arm 220 is connected to the base 210, and the pivot 230 is provided at the other end 220b of the support arm 220 to be pivotally connected to the light emitting device 240 and the support arm 220. In this way, a user can adjust the light direction of the light emitting device 240 by the pivot 230, therefore a bright working environment at the desk is built. The light emitting device 240 of the embodiment will be described in detail hereinbelow.

Please refer to FIG. 2. The light emitting device 240 of the embodiment includes a lampshade 242, a LED light assembly 244 provided at the lampshade 242 and at least a heat pipe 246 (FIG. 2 only shows one heat pipe.). In the embodiment, the lampshade 242 is pivotally connected to the end 220b of the support arm 220 via the pivot 230, and the heat pipe 246 directly contacts with the LED light assembly 244, wherein the LED light assembly 244 of the embodiment is, for example, composed of a circuit board 244a and a plurality of LEDs 244b. The LEDs 244b are provided at one surface of the circuit board 244a, and the heat pipe 246 is provided at the other surface of the circuit board 244a. In addition, one end 246a of the heat pipe 246 extends to the pivot 230 and is tightly fitted with the pivot 230. In this way, the heat produced by the LED light assembly 244 can be conducted to the pivot 230 by the heat pipe 246, and then the heat can be conducted to the metal support arm 220 or the metal base 210 via the pivot 230.

Since the support arm 220 and the base 210 have a larger surface for heat convection with the surroundings, when the heat produced by the LED light assembly 244 is conducted to the support arm 220 or the base 210, the heat can be dissipated to the surroundings via the heat convection.

In addition, the LED table lamp 200 also can be provided with a lens 250. The lens 250 is provided at the area where the light is emitted out from the lampshade 242 to make the light emitted by the LED light assembly 244 uniform, so that the user can be provided with gentle light.

According to the description of the present invention above, the heat pipe is used to conduct the heat produced by the LED light assembly to the metal pivot, and then the heat is conducted to the support arm or the base via the pivot to be dissipated. Since the support arm and base has a larger surface for heat convection with the surroundings, the heat produced by the LED light assembly can be dissipated to the surroundings effectively by the metal support arm or the metal base, so that the LED light assembly can be in a normal working temperature, and the LED table lamp has a longer working lifespan. Compared with the conventional LED light assembly with bigger and heavier heat dissipation fins assembly, the embodiment of the present invention has the following advantages:

First, in one preferred embodiment of the present invention, a heat pipe is used to conduct the heat produced by the LED light assembly to the metal support arm or the metal base, so that the heat can have the convection with the surroundings by the support arm or the base. Therefore, the light emitting device of the present invention is more light and slim, and the LED table lamp of the present invention has a preferred product appearance.

Second, since the heat produced by the LED light assembly is conducted to the metal support arm or the metal base via the heat pipe for heat dissipation, there is no need to have openings on the lampshade for a better heat dissipation. In other word, the LED table lamp of the present invention has a preferred product appearance.

Third, since the light emitting device is lighter and slimmer, the LED table lamp of the present invention needs only normal support for the light emitting device. That is, the LED table lamp of the present invention has a lower product cost without special heavy support.

Although the present invention has been described in considerable detail with reference to certain preferred embodiments thereof, the disclosure is not for limiting the scope of the present invention. Persons having ordinary skill in the art may make various modifications and changes without departing from the scope and spirit of the present invention. Therefore, the scope of the appended claims should not be limited to the description of the preferred embodiments described above.

What is claimed is:

1. A light emitting diode table lamp comprising:
a base;
a support arm, wherein one end of the support arm is connected to the base;
a pivot provided at the other end of the support arm;
a light emitting device comprising:
a lampshade pivotally connected to the support arm by the pivot;
a light emitting diode light assembly provided in the lampshade; and
at least a heat pipe, wherein the heat pipe is provided at the light emitting diode light assembly, and one end of the heat pipe is tightly fitted with the pivot.

2. The light emitting diode table lamp according to claim 1, wherein the light emitting diode light assembly further comprises a circuit board, so that the light emitting diode light assembly is provided at one surface of the circuit board, and the heat pipe is provided at the other surface of the circuit board.

3. The light emitting diode table lamp according to claim 1, wherein the material of the pivot and the support arm is metal.

4. The light emitting diode table lamp according to claim 1, wherein the material of the base is metal.

5. The light emitting diode table lamp according to claim 1, the light emitting diode table lamp further comprises a lens provided at the lampshade to make the light emitted by the light emitting diode light assembly uniform.
